(19) United States
(12) Patent Application Publication
(10) Pub. No.: US 2011/0303104 A1
(43) Pub. Date: Dec. 15, 2011

(54) CHAFING DISH ASSEMBLIES

(76) Inventor: Hongyuan Han, Morris Plains, NJ (US)

(21) Appl. No.: 13/157,167

(22) Filed: Jun. 9, 2011

Related U.S. Application Data
(60) Provisional application No. 61/344,205, filed on Jun. 10, 2010.

(51) Int. Cl. A47J 36/24

(52) U.S. Cl. 99/483

(57) ABSTRACT

A chafing dish assembly includes a stand having at least one heat source holder and a heat diffusing plate mounted to the stand directly above the heat source holder. The heat diffusing plate has a lower surface facing the heat source holder and an upper surface adapted to support a food containing vessel.

### CROSS REFERENCES TO RELATED APPLICATIONS

This application claims the benefit of U.S. Provisional Application No. 61/344,205, filed Jun. 10, 2010, which is hereby incorporated by reference.

### BACKGROUND OF THE INVENTION

This invention relates generally to chafing dish assemblies and more particularly to chafing dish assemblies having a heat diffusing plate for providing more even heating of food.

Buffets are a popular way of serving meals in the food service industry, as well as for home entertaining. In buffet-style service, food is served in containers, typically referred to as chafing dishes or buffet pans, set up in a dining area remote from where the food was prepared. Such chafing dishes are usually supported on a stand over a source of heat to keep the food warm for as long as possible. To avoid burning the food, these assemblies often include a pan containing hot water placed between the chafing dish and the heat source. That is, the chafing dish is nested on top of the water pan, and both are supported on the stand over the heat source. The water is thus heated by the heat source, and the hot water evenly heats the chafing dish and the food contained therein.

The use of water pans is not without drawbacks, however. For one thing, the use of water pans makes for a more involved set up of the food serving assemblies and results in more equipment that needs to be cleaned afterward. In addition, the water can take a long time (and a significant amount of energy) to be heated to the necessary temperature. Using water pans also can be messy and result in water spills. When food is served for an extended period, the water pans must be monitored and occasionally re-filled with water or else they can boil dry, rendering their heat distribution function ineffective.

Accordingly, it would be desirable to have a chafing dish assembly that avoids burning the food without the use of a water pan.

### SUMMARY OF THE INVENTION

The above-mentioned need is met by the present invention, which provides a chafing dish assembly that includes a stand having at least one heat source holder and a heat diffusing plate mounted to the stand directly above the heat source holder. The heat diffusing plate has a lower surface facing the heat source holder and an upper surface adapted to support a food containing vessel.

### DESCRIPTION OF THE DRAWINGS

FIG. 1 is a side view of one embodiment of a chafing dish assembly.

FIG. 2 is a perspective view of a support stand from the chafing dish assembly of FIG. 1.

FIG. 3 is a side view of the support stand from the chafing dish assembly of FIG. 1.

FIG. 4 is a top view, in partial cut-away, of the support stand from the chafing dish assembly of FIG. 1.

FIG. 5 is a perspective view of another embodiment of a chafing dish assembly, without a food containing vessel.

FIG. 6 is a cross-sectional view taken along line 6-6 of FIG. 5.

FIG. 7 is a perspective view of the chafing dish assembly of FIG. 5 including a food containing vessel.

### DETAILED DESCRIPTION OF THE INVENTION

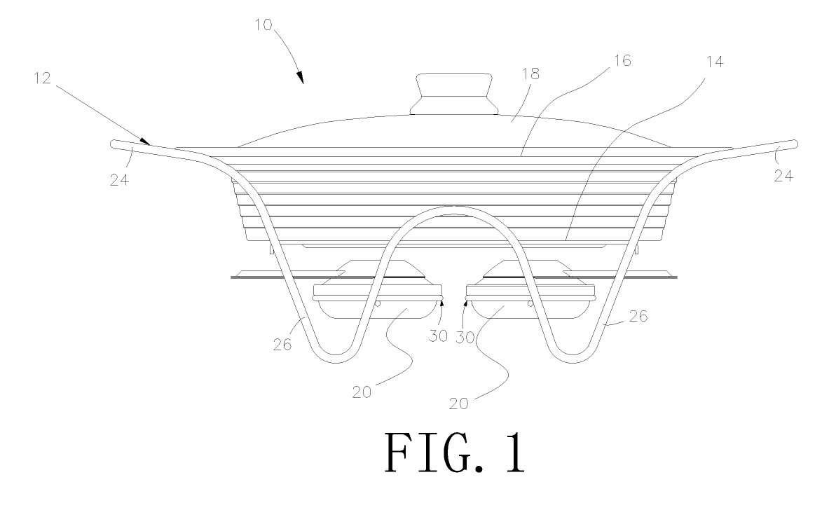

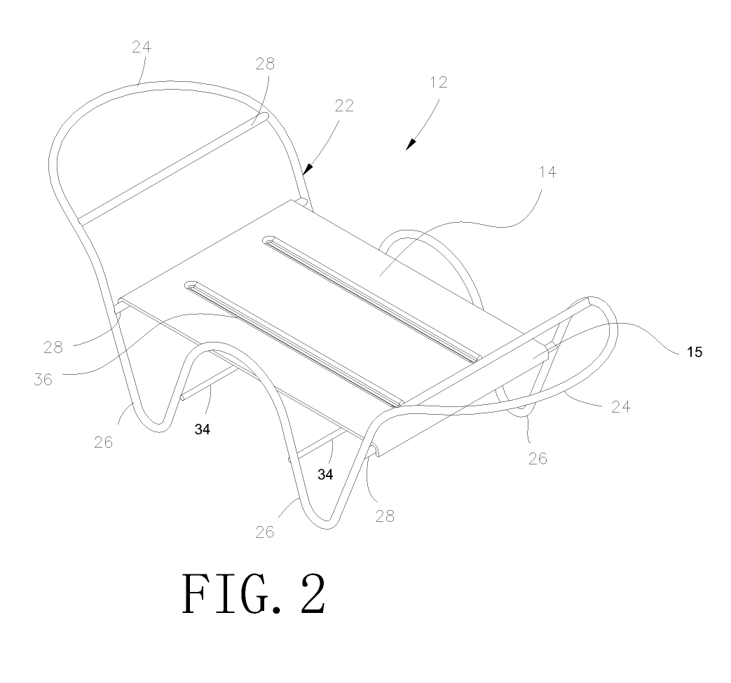

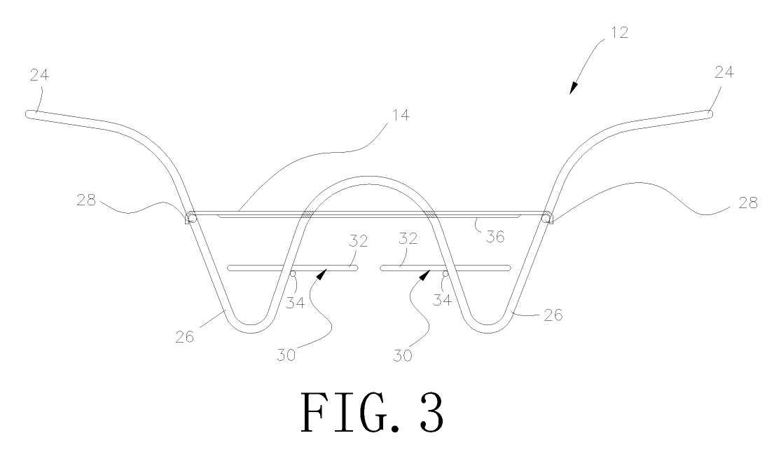

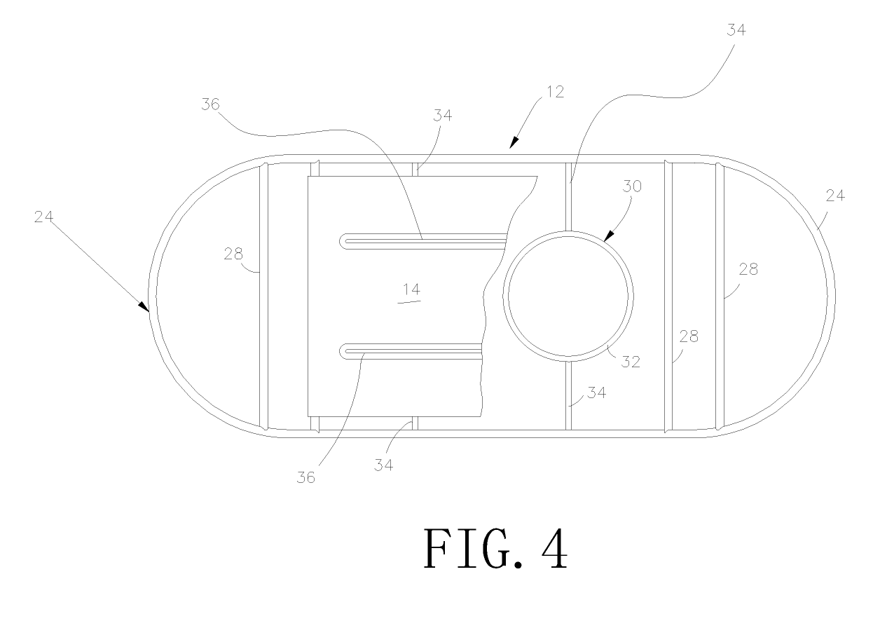

Referring to the drawings wherein identical reference numerals denote the same elements throughout the various views, FIGS. 1-4 show one embodiment of a chafing dish assembly 10. As used herein, the term “chafing dish assembly” is used to mean any device or apparatus that can be used to hold and present food for serving and also keep the food warm. The chafing dish assembly 10 includes a support stand 12 and a heat diffusing plate 14 mounted to the support stand 12 for supporting a food containing vessel 16, such as a chafing dish or buffet pan, and which includes a removable cover 18. The stand 14 also supports two heat sources 20 below the heat diffusing plate 14.

The support stand 12 includes a frame 22 made of a continuous length of wire rod bent into a closed loop configuration that defines a curved handle 24 at each end thereof. Each side of the frame 22 is further curved in an undulating fashion to define four legs 26 (two on each side of the frame 22) for supporting the chafing dish assembly 10 on a table top or similar surface. The wire rod is of a sufficient diameter such that the frame 22 is rigid and strong enough to support the food containing vessel 16 when loaded with food.

The support stand 12 further includes a number of cross bars 28 that extend side-to-side across the frame 22 and function to reinforce the frame 22. The cross bars 28 include a first pair extending across the frame 22 near the top of the handles 24 and a second, lower pair located at approximately mid-height of the frame 22. The lower pair of cross bars 28 supports the heat diffusing plate 14. Specifically, each of the lower cross bars 28 supports a corresponding end of the heat diffusing plate 14. The lower surface of the heat diffusing plate 14 sits on the lower cross bars 28, and the ends 15 of the heat diffusing plate 14 are curved downwardly so as to nestle on the cross bars 28. The heat diffusing plate 14 can be affixed or secured to the lower cross bars 28 by any suitable means such as welding, solder, fasteners, or the like.

Two heat source holders 30 extend side-to-side across the frame 22 below the heat diffusing plate 14. Each heat source holder 30 comprises a ring 32 and two wire rod support members 34 extending outward from opposite sides of the ring 32. The outer end of each support member 34 is joined to a correspond leg 26 of the frame 22 so as to position the ring 32 midway between the two sides of the frame 22 as well as providing additional reinforcement of the frame 22. Each ring 32 is sized to receive and hold a heat source 20. In the illustrated embodiment, the heat sources 20 are heating fuel containers, which contain heating fuel (sometimes also referred to as chafing dish fuel), such as an alcohol-based liquid or gel.

The heat diffusing plate 14 is located directly above the heat source holders 30 and the heat sources 20, with an unobstructed space defined therebetween so that heat emitted from the heat sources 20 directly impinges on the lower surface of the heat diffusing plate 14, which is facing the heat sources 20. That is, the lower surface of the heat diffusing plate 14 is directly exposed to the heat sources 20 with an unobstructed “line of sight.” The heat diffusing plate 14 is a plate that is capable of supporting the food containing vessel 16 and also diffusing heat from the heat sources 20 so as to evenly distribute the heat to the food containing vessel 16 supported on the upper surface thereof. To this end, the heat diffusing plate 14 can be made of any suitable material, but is preferably made of a material that has high thermal conductivity (i.e., generally greater than about 10 watts per Kelvin-meter) and is sufficiently strong to support the food containing vessel 16. Suitable materials include, but are not limited to, metals or metal alloys such as aluminum, carbon steel, stainless steel, copper and brass. The heat diffusing plate 14 is also sufficiently thick to ensure even heat distribution. That is, the plate thickness is such that there is sufficient mass per unit area to avoid hot spots in the upper surface of the heat diffusing plate 14. For example, a stainless steel heat diffusing plate would have a thickness of approximately 1.8-2.5 millimeters to ensure even heat distribution. The heat diffusing plate 14 could be made even thicker, but this would result in a heavier, more expensive plate with little or no improvement in heat distribution.

The heat diffusing plate 14 is sized to support the food containing vessel 16 on the upper surface thereof. The shape of the heat diffusing plate 14 can generally match the shape of the food containing vessel 16. The heat diffusing plate 14 is rectangular in the illustrated embodiment, but other shapes such as oval and circular are also possible. The heat diffusing plate 14 has two beams or ribs 36 formed therein to increase its structural integrity. The ribs 36 are preferably integrally formed in the heat diffusing plate 14, forming recesses on the upper surface and protrusions on lower surface. This permits the food containing vessel 16 to rest flush on the upper surface and provide good thermal contact between the food containing vessel 16 and the heat diffusing plate 14. The ribs 36 are parallel to one another and extend lengthwise or longitudinally with respect to the heat diffusing plate 14 and function to reinforce or stiffen the heat diffusing plate 14, enabling it to better support the weight of the food containing vessel 16.

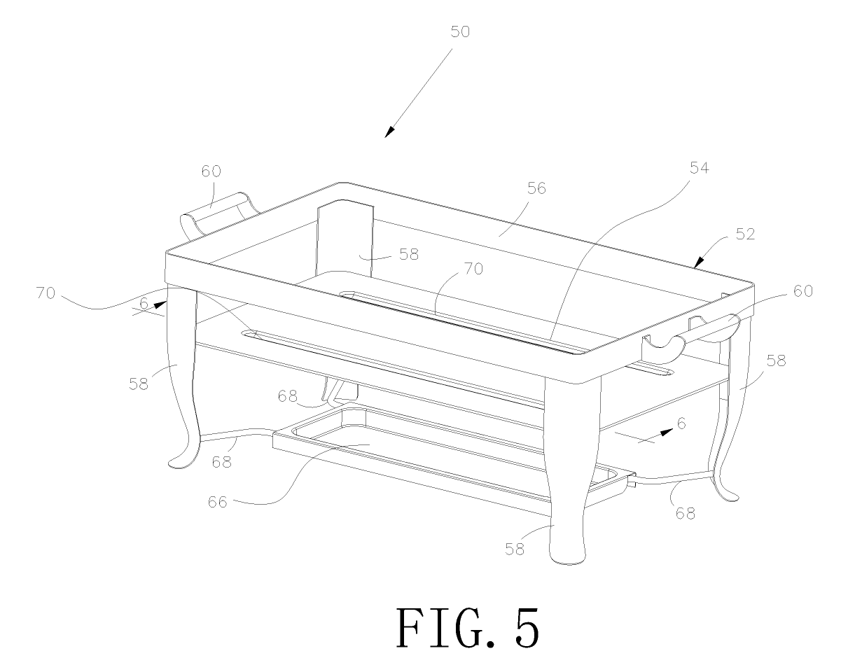

Referring to FIGS. 5-7, another embodiment of a chafing dish assembly 50 is shown. The chafing dish assembly 50 includes a support stand 52 and a heat diffusing plate 54 mounted on the support stand 52 for supporting a food containing vessel 55 (not shown in FIG. 5). The support stand 52 comprises a generally rectangular, open frame 56 having four rounded corners and four legs 58 attached to the frame 56 for supporting the chafing dish assembly 50 on a table top or similar surface. Each leg 58 is attached at its upper end to the frame 56 in a corresponding corner thereof. The lower ends of the legs 58 are configured to contact the surface supporting the chafing dish assembly 50. Two handles 60 are attached to the frame 56, one at each end thereof.

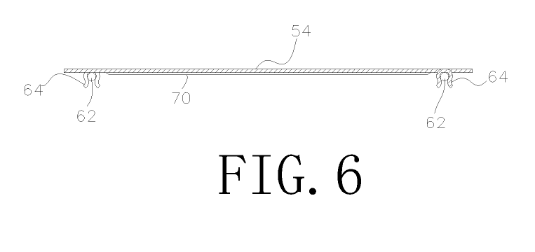

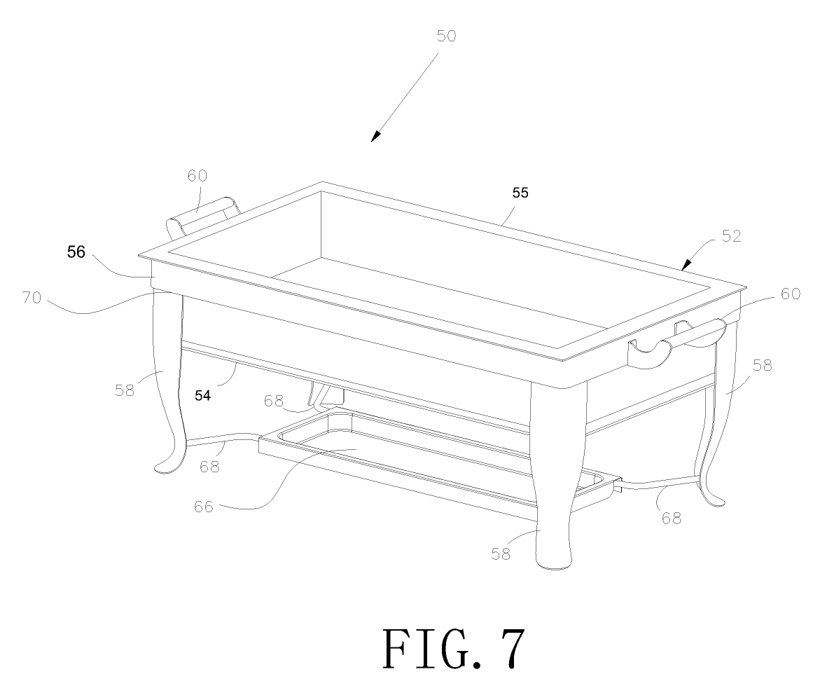

The heat diffusing plate 54 is supported by the legs 58 below the frame 56. The heat diffusing plate 54 is positioned at or near the middle of the legs 58. The distance between the heat diffusing plate 54 and the frame 56 is such that the food containing vessel 55 can be placed within the frame 56 and rest on the upper surface of the heat diffusing plate 54, as shown in FIG. 7, making good thermal contact therewith. In one possible implementation, as shown in FIG. 6, the heat diffusing plate 54 is supported by a pair of cross bars 62 extending side-to-side across the support stand 52. Specifically, each cross bar 62 extends between and is connected to a corresponding pair of the legs 58. Fastener clips 64 are formed on the lower surface of the heat diffusing plate 54 near each end thereof. The fastener clips 64 engage the cross bars 62 and secure the heat diffusing plate 54 thereto.

Turning back to FIG. 5, the support stand 52 further includes a heat source holder 66 in the form of a tray supported from the legs 58 by four struts 68. The heat source holder or tray 66 is positioned directly below the heat diffusing plate 54 and can hold several heat sources (not shown) such as heating fuel containers. The heat source holder 66 and the heat diffusing plate 54 define an unobstructed space therebetween so that heat emitted from the heat sources directly impinges on the lower surface of the heat diffusing plate 54. As with the first embodiment discussed above, the heat diffusing plate 54 is a plate having a high thermal conductivity and sufficient thickness so as to evenly distribute the heat from the heat sources to a food containing vessel placed on the upper surface thereof. The heat diffusing plate 54 also has two beams or ribs 70 formed therein to increase its structural integrity.

While specific embodiments of the present invention have been described, it should be noted that various modifications thereto can be made without departing from the spirit and scope of the invention as defined in the appended claims.

What is claimed is:

1. A chafing dish assembly comprising:
a stand including at least one heat source holder; and
a heat diffusing plate mounted to said stand directly above said heat source holder, said heat diffusing plate having a lower surface facing said heat source holder and an upper surface adapted to support a food containing vessel.

2. The chafing dish assembly of claim 1 wherein said heat diffusing plate has one or more ribs formed therein to increase structural integrity of said heat diffusing plate.

3. The chafing dish assembly of claim 1 wherein said heat diffusing plate is rectangular in shape and has two longitudinally extending ribs formed therein.

4. The chafing dish assembly of claim 1 wherein said heat diffusing plate is made of a material having high thermal conductivity.

5. The chafing dish assembly of claim 1 wherein said heat diffusing plate has a sufficient thickness to ensure even heat distribution.

6. The chafing dish assembly of claim 1 wherein said stand includes two cross bars that support said heat diffusing plate.

7. A chafing dish assembly comprising:
a stand including at least one heat source holder;
a heat diffusing plate mounted to said stand directly above said heat source holder, said heat diffusing plate having a lower surface facing said heat source holder and an upper surface; and
a food containing vessel supported on said upper surface.

8. The chafing dish assembly of claim 7 further comprising a heat source held in said heat source holder.

9. The chafing dish assembly of claim 8 wherein said heat source is a heating fuel container.

10. The chafing dish assembly of claim 8 wherein said heat source and said heat diffusing plate define an unobstructed space therebetween so that heat emitted from said heat source directly impinges on said lower surface of said heat diffusing plate.

11. The chafing dish assembly of claim 8 wherein said heat source holder is a ring configured to receive a heating fuel container.

12. The chafing dish assembly of claim 8 wherein said heat source holder is a tray that can support multiple heating fuel containers.

13. The chafing dish assembly of claim 7 wherein said heat diffusing plate has one or more ribs formed therein to increase structural integrity of said heat diffusing plate.

14. The chafing dish assembly of claim 7 wherein said heat diffusing plate is rectangular in shape and has two longitudinally extending ribs formed therein.

15. The chafing dish assembly of claim 7 wherein said heat diffusing plate is made of a material having high thermal conductivity.

16. The chafing dish assembly of claim 7 wherein said heat diffusing plate has a sufficient thickness to ensure even heat distribution.

17. The chafing dish assembly of claim 7 wherein said stand includes two cross bars that support said heat diffusing plate.
